(19) United States
(12) Patent Application Publication
(10) Pub. No.: US 2023/0235654 A1
(43) Pub. Date: Jul. 27, 2023

(54) Natural Gas Fracturing Engine System and Method

(71) Applicant: CATALYST, Midland, TX (US)

(72) Inventors: Sean Dee EDWARDS, Midland, TX (US); Seth Richard MOORE, Midland, TX (US); Bobby Joe CHAPMAN, Midland, TX (US)

(21) Appl. No.: 18/100,430

(22) Filed: Jan. 23, 2023

Related U.S. Application Data
(60) Provisional application No. 63/301,894, filed on Jan. 21, 2022.

(51) Int. Cl. E21B 43/26; F02B 43/10; F04B 17/05

(52) U.S. Cl. CPC E21B 43/2607; F02B 43/10; F04B 17/05; F02B 2043/103

(57) ABSTRACT

A natural gas engine is utilized for fracturing. The natural gas engine can utilize recovered natural gas as the fuel source. This eliminates the need for expensive diesel fuel. The natural gas system results in several benefits including economic savings as well as environmental advantages in the reduction of particulate, greenhouse gases, including NOx, methane, CO2, CO, VOC etc.

### TECHNICAL FIELD

The present invention claims priority to Provisional Application No. 63/301,894 filed Jan. 21, 2022, the entirety of which is hereby incorporated by reference.

### BACKGROUND OF THE INVENTION

### Technical Field

The present invention relates to a system and method for a natural gas fracturing engine.

### DESCRIPTION OF RELATED ART

Fracturing requires significant power and torque. Using diesel and other fuels has significant logistical and environmental concerns. Consequently, there is a need for an engine which uses alternative fuels.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a natural gas engine in one embodiment;

FIG. 2 is a schematic of a natural gas engine system in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

Fracturing involves injecting fluids downhole at high pressures to create fractures in the subterranean structures. This allows for more efficient recovery of natural gas and oil, whose recovery may not have been possible or economically feasible.

Previously, diesel engines were used to provide the power and torque necessary for the fracturing. While diesel engines can supply the necessary torque and power, there are significant drawbacks to diesel engines.

As but one example, one specific diesel engine consumes approximately 2,000 gallons of diesel fuel per days. A frac job may use up to 24 or even more of these engines simultaneously daily. That means roughly 40,000 gallons of diesel fuel must be delivered to the diesel engine every day. Often the fracturing sites are in remote locations. Significant fuel trucks are needed to deliver the volume of diesel consumed daily. This results in wear and tear on the roads. Additionally, arranging fuel trucks requires logistics to align delivery, prepare and maintain the road which allows delivery, etc. Furthermore, because you cannot always count on the delivery trucks to be there exactly when needed, the operator must have storage tanks to store the diesel fuel. This results in a larger well pad to accommodate all of the stored and ready to burn diesel fuel. This is in addition to the traffic congestion due to the fuel tanks, the wear and tear of the road previously described, etc.

Aside from damage to the road, larger pad, etc. the diesel engines yield significant noise output. Diesel engines are loud. Noise limitations and abatement requirements can limit where diesel engines can be placed. Furthermore, the diesel engines result in high thermal output due to the high operating temperatures. This is due to the comparative heavier molecular structure of diesel fuel compared to gasoline, as an example.

Due to the nature of diesel fuel, a diesel engine produces greater noise and thermal output, as discussed above. However, diesel engines also offer shorter component life. Thus, the maintenance of diesel engines is more intense compared to other fuels.

For the reasons stated above, while diesel engines can meet the power and torque requirements of fracturing, there are significant disadvantages. These disadvantages require extra cost, logistical planning, increased capital, and operational expenses.

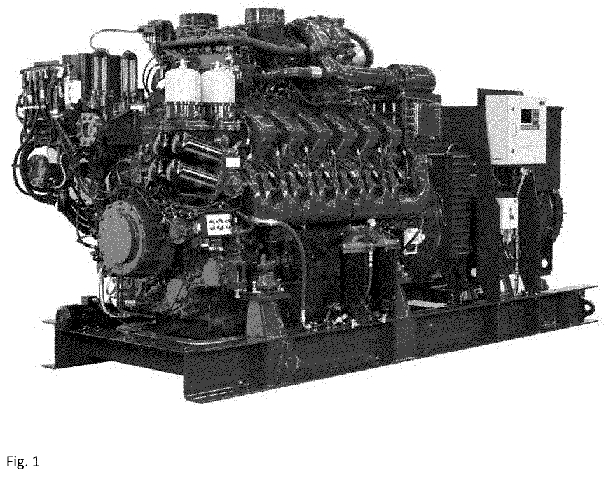

In one embodiment, a natural gas fracturing engine is utilized. FIG. 1 is a perspective view of a natural gas engine in one embodiment. In one embodiment the natural gas engine burns 100% natural gas. In one embodiment, 100% of the fuel utilized by the natural gas engine has been recovered on the same fracturing site. The term “natural gas” can comprise natural gas, field gas, pipeline gas, CNG, LNG, etc.

A natural gas fracturing engine overcomes many of the disadvantages associated with a diesel engine, as addressed above.

In one embodiment, the natural gas fracturing engine utilizes natural gas which is recovered at the well site. As noted, the fracturing site recovers natural gas and oil. Thus, in one embodiment, the natural gas recovered at the fracturing site is used to fuel one or more of the fracturing engines. This eliminates many of the problems discussed above.

First, because the natural gas recovered is used at the site, when of sufficient volume, there is no need for fuel trucks to supply the fuel. This results in a decrease in traffic, logistics required for the fuel trucks, the operational cost of the fuel cost, etc.

Eliminating the fuel trucks reduces the wear and tear on the road, as well as the road maintenance required. This is a significant advantage.

Second, by using recovered natural gas as opposed to delivered diesel fuel, the cost of diesel fuel consumed by the fracturing engine(s) is eliminated or greatly reduced. Certainly there is still a fuel cost because the engine is now consuming natural gas, but that cost is reduced considerably. Depending on the respective costs of the fuel, the cost of natural gas is generally about $1.5-3.00 per diesel gallon equivalent cheaper than diesel, or more. Thus, fuel costs are significantly reduced. They are likely reduced even further since the transportation costs of the natural gas has been eliminated as it is recovered and utilized at the same site.

Third, by eliminating the transportation of both the recovered natural gas which is utilized on site, as well as the transportation of the diesel fuel to the site, the fuel consumed attributable to transportation is reduced. This results in cost savings as well as less emissions due to transportation. As all of the fuel trucks which come and go from the site delivering diesel fuel are no longer doing so, and accordingly, the fuel consumed for the fuel trucks is not consumed. This results in less fuel being consumed as well as the accompanying reduction in emissions.

Fourth, because there is no need to store excess fuel in the event fuel trucks are unable to make a delivery, there can be less storage tanks compared to using diesel fuel. This results in less capital for the drilling site as well as a comparatively smaller footprint due to the reduced storage tanks.

Fifth, the natural gas engine offers lower exhaust temperatures, decreased noise, and longer component life compared to diesel engines. This has many obvious advantages. The natural gas engine can be placed in locations with stricter noise requirements, as an example. Further, because there is increased component life, the required maintenance costs, losses due to down time, etc. is reduced. When burning diesel fuel, there is a dilution of oil. Diesel-diluted lubricants increases wear on rings, bearings, etc., which must be replaced and repaired. However, using a natural gas engine extends the life of these components. Because of this the ability to maintain the desired emission efficiency with the engine is lengthened. Furthermore, because of the extended component life, the cost of Maintenance, Repair and Overhaul (“MRO”) is reduced.

A sixth benefit is the lower particulate, VOCs, CO, TOC, CO2 and reduced NOx and greenhouse gasses emissions of a natural gas engine compared to a diesel engine. As previously noted, a reduction in emissions is already achieved due to the elimination or reduction of fuel transport costs. However, burning natural gas compared to diesel results in lower particulate and NOx emissions. Thus, there is a dual emissions benefits achieved by utilizing natural gas compared to diesel engines.

In one embodiment, as an example, the natural gas fracturing engine consumes about 6,370 mcf of natural gas per day. In one embodiment, the engine is a 3,000-3,5000 HP engine.

Depending on the flow rate, price of diesel, number of engines, etc., the fuel savings can be well over a million dollars a month. This is over and above the other benefits, including environmental, previously discussed. This is simply the reduction in fuel cost by eliminating the cost of diesel fuel.

Natural gas is cleaner than diesel. Accordingly, in one embodiment few fuel filters are required per engine. In one embodiment, up to 7 less fuel filters per engine are used compared to a diesel engine. This is a reduction in operational costs, maintenance, etc.

As but one example, in one embodiment the ability to use fewer fuel filters resulted in 112 fewer fuel filters per 250 hours of operation. This is based on one embodiment where 7 filters are changed on 16 engines every 250 hours. In the embodiment for comparison, there were 7 filters on the diesel engine and none on the natural gas engine utilized. In one embodiment the fleet has 20 units pumping but only 16 usually pump, with 7 each on the diesel engine. The fleet pumps average about 4,800 hours per year. If filters are changed every 250 hours, this equates to about 19.2 changes per year. The average filter weighs about 3 pounds each and costs about $47.64 each. This equates to a reduction of about 2,150 filters annually with a corresponding waste reduction of about 6,450 pounds of metal waste. This results in a savings of approximately $102,200 in economic savings per year. Thus, the ability to utilize a natural gas engine results in the elimination or reduction of filters. This has an environmental and economic benefit in some embodiments.

Additionally, depending upon the site, the natural gas produced is often viewed as a waste stream. The system and method discussed herein converts a waste stream into a fuel stream. For the reasons addressed above, this results in significant economic and environmental benefits.

In one embodiment, the natural gas fracturing engines can provide the torque, adaptability to operating conditions, and high pressures required for a fracturing process. It has previously been believed that only a diesel engine could meet the dynamic and ever-changing operational parameters necessary for fracturing. However, it has been discovered, that the natural gas engines can meet the operational parameters. In some embodiments the natural gas engines are coupled to a gear box, transmission, or the like, to provide the engine to interact with the pumps at the appropriate RPM.

In one embodiment, this natural gas frac system includes integrated frac control software that converts the user's output requirements, based on the frac design, to engine control module (ECM) commands that in turn signal the fuel control system to make necessary adjustments in order to achieve the desired overall unit output.

In one embodiment, fuel pressure and volume are regulated to the specs of the engine manufacturer (OEM), whereby the engine fuel control system adjusts fuel flow to meet the demands of the engine requirement to achieve the desired outcome. With one design, the integrated frac control software signals the ECM to make adjustments to the fuel control system to produce the required engine horsepower to achieve the desired pump output.

In one embodiment, the integrated frac control software signals the fuel control system to adjust values to achieve the desired pump output.

As noted, a system for fracturing with a natural gas powered engine has been described. First, an engine is coupled to a frac pump. The frac pump is used for fracturing. Natural gas is used to power the engine, which in turn, powers the frac pump. In one embodiment, natural gas recovered from the fracturing process is used to power the engine. The fracturing process results in production of oil, natural gas, etc. Thus, in one embodiment, the natural gas recovered from the fracturing process is used to power the engine which facilitates further fracturing. This eliminates, or reduces, the need to bring fuel to the fracturing location, which is often remote. Some fuel may be required to initiate fracturing, or to supplement the fuel supply in some embodiments.

As noted, in one embodiment the system includes integrated frac control software which signals the fuel control system to adjust values to achieve the desired pump output. Such software determines the proper amount of fuel to achieve the desired pump output in terms of horsepower, torque, flowrate, etc.

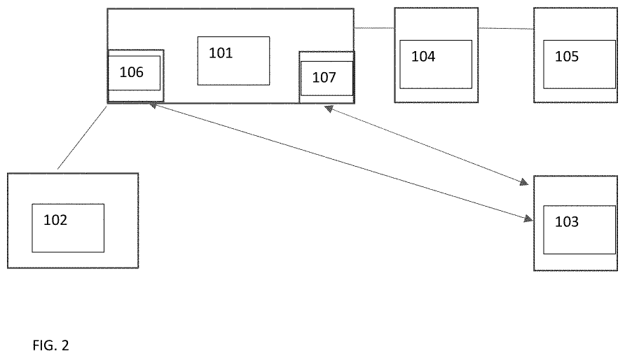

FIG. 2 is a schematic of a natural gas engine system in one embodiment. The natural gas engine 101 is as previously described. The natural gas fuel source 102 can comprise virtually any natural gas fuel source. This can comprise a pipeline, tank, storage, etc. Further, this can comprise natural gas recovered during the fracturing process.

The user interface 103 controls the natural gas engine 101. As shown, there is a drive train 104 which couples the natural gas engine 101 with the pump 105. Those of ordinary skill will understand the various drive trains 104 which can be utilized. Various types of pumps 105 can be utilized in the fracturing process.

The user interface 103, in one embodiment, is in communication with the fuel control system 106. As noted, the fuel control system 106 controls the amount of fuel received by the natural gas engine 101.

In one embodiment, and as shown, the user interface 103, is also coupled with an engine control module (ECM) 107.

Now that a system has been described, a method of utilizing the system, in one embodiment will be described. The method comprises the steps of coupling a natural gas engine to a frac pump. Then, natural gas is fed to the natural gas engine. The natural gas engine in turn powers the frac pump. The frac pump is used for fracturing.

While the invention has been particularly shown and described with reference to a preferred embodiment, it will be understood by those skilled in the art that various changes in form and detail may be made therein without departing from the spirit and scope of the invention.

What is claimed is:

1. A system for fracturing, said system comprising:
a natural gas engine coupled to a pump;
wherein said natural gas engine utilizes recovered natural gas as a fuel.

2. The system of claim 1 further comprising a gear box between said pump and said engine.

3. The system of claim 1 wherein said natural gas engine runs 100% on natural gas.

4. The system of claim 1 wherein said natural gas engine runs 100% on recovered natural gas.

5. A method of fracturing, said method comprising the steps of:
a) coupling a natural gas engine to a fracturing pump;
b) delivering natural gas to said natural gas engine;
c) powering said fracturing pump via said natural gas engine.

6. The method of claim 5 wherein said delivering of step b) comprises delivering recovered natural gas.
